(19) United States
(12) Patent Application Publication
(10) Pub. No.: US 2025/0386159 A1
(43) Pub. Date: Dec. 18, 2025

(54) NIMO-BASED NANOMATERIAL EARPHONE DIAPHRAGM

(71) Applicants: HIFIMAN KUNSHAN TECHNOLOGY GROUP CO., LTD, Kunshan (CN); HIFIMAN TECHNOLOGY CO., LTD., Tianjin (CN); NANKAI UNIVERSITY, Tianjin (CN)

(72) Inventors: Fang BIAN, Kunshan (CN); Wen GU, Tianjin (CN); Yunfang YAN, Tianjin (CN)

(21) Appl. No.: 19/197,804

(22) Filed: May 2, 2025

(30) Foreign Application Priority Data
Jun. 13, 2024 (CN) 202410757575.1

(51) Int. Cl. H04R 31/00; H04R 1/10; H04R 7/02

(52) U.S. Cl. CPC H04R 31/003; H04R 1/1058; H04R 7/02; H04R 2307/021; H04R 2307/027

(57) ABSTRACT

The present disclosure discloses a NiMo-based nanomaterial earphone diaphragm sand a preparation method thereof. The diaphragm uses a paper base film as the basis, and a uniform distribution of a NiMo-based nanomaterial coating is formed on a surface of the base film by plasma modification and electrostatic spraying technology, forming a concentric ring structure and using the NiMo-based nanomaterial as connecting lines to enhance the stability and conductive performance of the overall structure. This design not only significantly improves the audio quality performance of the earphones, including clarity, detail restoration, and dynamic range, but also greatly improves the durability and environmental adaptability of the diaphragm. The present disclosure provides an innovative solution for high-end earphone manufacturing, and is especially suitable for music lovers who pursue the ultimate audio experience and professional audio fields.

### CROSS-REFERENCE TO RELATED APPLICATION

The present disclosure claims priority to Chinese Patent Application No. 202410757575.1 filed on Jun. 13, 2024, which is incorporated herein by reference in its entirety.

### TECHNICAL FIELD

The present disclosure relates to the technical field of earphone diaphragms, and in particular, to a NiMo-based nanomaterial earphone diaphragm.

### BACKGROUND

With the advancement of science and technology and the increasing demand for audio quality among consumers, the performance of earphone diaphragms has become increasingly important. Although traditional earphone diaphragm materials, such as metal, plastic or polymer, can meet basic acoustic needs, they have limitations in terms of lightweight, high sensitivity and wide frequency response. In recent years, nanomaterials have shown great potential in improving the performance of earphone diaphragms due to their unique physical and chemical properties.

NiMo-based nanomaterials have become one of the most concerned new materials in the field of earphone diaphragms due to their excellent mechanical properties, high conductivity and good acoustic properties. However, traditional methods for preparation of NiMo-based materials are often complex and costly, and it is difficult to achieve precise control and functionalization of the materials. In addition, the structural design of the diaphragm on the acoustic performance has aroused attention gradually, especially factors such as material distribution, coating thickness, and layout of connecting lines, which are directly related to the vibration mode, acoustic wave conduction efficiency, and overall stability of the diaphragm.

In order to solve the above problems, a NiMo-based nanomaterial earphone diaphragm and a preparation method thereof are proposed herein. The diaphragm is prepared from a MoNiP₂/Ni₃S₂/MoS₂ nanomaterial by fine processing, with an innovative structural design, that achieves the unity of high acoustic performance and conductive performance. By controlling the microstructure and macroscopic layout of the material, the acoustic response of the diaphragm is not only improved, but also its conductive efficiency is enhanced, opening up a new way for the development of high-performance earphones. In addition, the preparation method of the present disclosure simplifies the process flow, reduces costs, and provides a feasible solution for large-scale production of high-performance earphone diaphragms.

### SUMMARY

In order to solve the above problems, the present disclosure provides a NiMo-based nanomaterial earphone diaphragm, including a base film and a NiMo-based nanomaterial sprayed on surface of the base film, where the base film is circular, the nanomaterial is sprayed on the surface of the base film in a concentric ring form to form a NiMo-based nanomaterial coating, concentric rings are interconnected by connecting lines, and materials of the connecting lines are also the NiMo-based nanomaterial.

The NiMo-based nanomaterial is a MoNiP₂/Ni₃S₂/MoS₂ nanomaterial, specifically a rod-shaped cluster structure with a length of rods being about 20 μm and a width of rods being between 1.5 and 2 μm.

The NiMo-based nanomaterial coating has a thickness of 300-500 μm.

The base film is a paper base film having a uniform thickness in a range of 10-50 μm and density, and the base film is made from wood pulp, cotton pulp or bamboo pulp.

A method for preparing the NiMo-based nanomaterial earphone diaphragm, including the following steps:
step A: preparation of the base film
preparing a paper base film to ensure that the base film has a uniform thickness and density, where the base film is made from high-purity wood pulp, cotton pulp or bamboo pulp as raw materials;
step B: pretreatment of the base film
cleaning the surface of the base film to remove impurities, and performing surface modification to enhance material adhesion;
step C: preparation of the NiMo-based nanomaterial
preparing a precursor first, then vulcanizing the precursor to prepare a MoNiP₂/Ni₃S₂/MoS₂ nanomaterial;
step F: spraying of the NiMo-based nanomaterial
spraying the NiMo-based nanomaterial evenly on the surface of the paper base film to form a concentric ring distribution; ensuring uniform material distribution without bubbles and cracks, and keeping the thickness of the coating between 300-500 μm; and
step G: spraying of the connecting lines
spraying the NiMo-based nanomaterial as connecting lines between the concentric rings to ensure structural integrity of the diaphragm as a whole.

The preparation of the NiMo-based nanomaterial is as follows:
step C1: preparation of a precursor
firstly, the precursor of a NiMo-based sulfur-phosphorus hybrid catalyst is prepared by a two-step hydrothermal method; in the first step, ammonium molybdate is used as a source of molybdenum and phosphorus, mixed with nickel nitrate hexahydrate and dissolved in deionized water to form a mixture, and the mixture is stirred to form a uniform solution; subsequently, a cleaned nickel foam skeleton is immersed in the solution and heated to 150 degrees Celsius in a 25 mL Teflon-lined autoclave for 6 h; after cooling to room temperature, the obtained product is washed with deionized water and ethanol several times and dried at 60 degrees Celsius for 12 h;
step C2: vulcanization process
100 mg of thiourea is taken and dissolved in 15 mL of deionized water, and transferred to a 25 ml Teflon autoclave after ultrasonic dispersion for 15 min, with the precursor soaked therein, so that liquid surface completely covers the precursor; the autoclave is heated to 200 degrees Celsius and kept warm for 20 h, then cooled to room temperature naturally; finally, the obtained product is washed with deionized water and ethanol several times, and dried again at 60 degrees Celsius for 12 h to obtain a black Ni foam, which is made from the MoNiP₂/Ni₃S₂/MoS₂ nanomaterial.

The specific steps for surface modification to enhance material adhesion in step B are as follows:
the base film needs to be cleaned to remove dust and grease on the surface, and ultrasonic cleaning and chemical solvent cleaning are used in a combined manner to ensure cleanliness of the surface of the base film;
the cleaned base film is placed in a plasma generator, and oxygen, argon or nitrogen is used to generate plasma; chemical properties of the surface of the base film are changed to increase surface energy, improve its hydrophilicity and surface activity, thereby enhancing the adhesion of subsequent spray materials;
after plasma treatment, a layer of adhesion promoter will be sprayed on the surface of the base film;
afterwards, ultraviolet light irradiation is performed to further improve surface activity and enhance adhesion; and
before spraying, the base film is preheated to increase surface temperature to enable rapid curing and better adhesion of the sprayed material.

The adhesion promoter is selected from a silane coupling agent or acrylics.

An ultraviolet wavelength is in a range of 250-280 nm, an irradiation intensity of the ultraviolet light is set to be 30-50 mW/cm², an exposure time of the base film under ultraviolet light is 10-20 min, and a distance between the ultraviolet light source and the surface of the base film is controlled between 10-20 cm.

The spraying of the NiMo-based nanomaterial in step F is as follows:
spraying preparation: the MoNiP₂/Ni₃S₂/MoS₂ nanomaterial is mixed with a solvent and an auxiliary agent to prepare a uniform and stable suspension, where the solvent is selected from deionized water or ethanol, and the auxiliary agent is selected from sodium dodecyl sulfate or polyvinyl pyrrolidone;
setting of spraying parameters: an electrostatic spraying equipment is used, a distance between a spray gun and the base film is adjusted to be 15-25 cm, a spraying voltage is set to be 30-50 kV, and an air pressure is 0.3-0.5 Mpa;
spraying operation: under constant spraying parameters, the prepared MoNiP₂/Ni₃S₂/MoS₂ suspension is evenly sprayed on the surface of the pretreated paper base film to form a concentric ring distribution, and the thickness of the coating is controlled between 300-500 μm;
spraying path planning: in order to ensure uniform distribution of the material, the spraying path needs to be planned in advance, and a spiral or reciprocating spraying path is used to avoid repeated spraying at the same location so as to avoid local accumulation; and
curing treatment: after the spraying is completed, the diaphragm is placed in an oven and subjected to heat treatment at 80-100° C. to promote the curing of the coating and enhance the adhesion and stability of the material.

The spraying of the connecting lines for the NiMo-based nanomaterial in step G is as follows:
preparation before spraying: after completing a preliminary spraying of the NiMo-based nanomaterial, it is ensured that the coating of the concentric rings on the base film is completely dry and without any defects;
design of the connecting lines: a location and direction of the connecting lines are determined to ensure that the connecting lines are evenly distributed among the concentric rings to form a grid structure and enhance the stability and conductive performance of the overall structure;
adjustment of spraying parameters: the parameters of an electrostatic spraying equipment are adjusted, including spraying voltage and air pressure;
spraying operation for the connecting lines: the same spraying equipment and parameters are used as in step F, the MoNiP₂/Ni₃S₂/MoS₂ nanomaterial suspension is accurately sprayed on a preset location of the connecting lines to form a continuous, uniform connecting line coating; and
secondary curing: after completing the spraying of the connecting lines, the diaphragm is placed in the oven again for a second curing process.

The planning method for the rings and the position of the connecting lines is as follows:
based on a diameter D of the earphone diaphragm and a center frequency f of the diaphragm, an optimal spacing and layout between the rings and the connecting lines are calculated to ensure the optimization of acoustic performance and conductive performance, using a formula:

$$S = v / 2 N π f ;$$

where v is a speed of sound waves propagating in air, f is a center frequency, S is a spacing of the rings, and N is a positive integer that is selected from 2 to 5;
in order to ensure good conductive performance, a density of the connecting lines should satisfy a formula:

$${D}_{c} = {I}_{max} / σ A ;$$

where Iₘₐₓ is the maximum operating current, σ is a conductivity of the NiMo-based nanomaterial, and A is a cross-sectional area of a single connecting line.

The beneficial effects of the present disclosure are:

The NiMo-based nanomaterial (MoNiP₂/Ni₃S₂/MoS₂) can provide excellent acoustic properties over a wide frequency range due to their unique rod-shaped cluster structure. The high elastic modulus and low damping characteristics of the material enable the diaphragm to respond to audio signals more accurately, reduce distortion, and improve sound quality clarity and detailed performance.

Spraying the NiMo-based nanomaterial between the concentric rings as the connecting lines not only enhances the overall structural stability of the diaphragm, but also ensures the reliability and consistency of the diaphragm during high-frequency vibration. This design effectively prevents the diaphragm from deforming or breaking after long-term use.

The high conductivity of the NiMo-based nanomaterial ensures a good electrical connection between the diaphragm and a drive unit, reduces energy loss in signal transmission, and improves the purity and dynamic range of sound.

The high hardness and wear resistance of the NiMo-based nanomaterial, combined with the precise spraying process, make the surface of the diaphragm more robust and resistant to minor scratches and wear in daily use, extending the service life of the earphones.

Based on the lightweight design of the paper base film combined with the excellent performance of the NiMo-based nanomaterial, the diaphragm can still maintain stable performance under different temperature and humidity environments, improving the applicability and reliability of the earphones under various environmental conditions.

### BRIEF DESCRIPTION OF DRAWINGS

In order to more clearly illustrate the embodiments of the present disclosure or the technical solutions in the existing technologies, the accompanying drawings that need to be used in the description of the embodiments or existing technologies will be briefly introduced below. Obviously, the drawings in the following description are only some embodiments of the present disclosure. For those of ordinary skill in the art, other figures can be obtained based on these drawings without exerting any creative effort.

FIG. 1 shows a scanning electron microscope (SEM) image of a NiMo-based nanomaterial of the present disclosure;

FIG. 2 shows X-Ray Diffraction (XRD) test results of the NiMo-based nanomaterial of the present disclosure;

FIG. 3 shows a frequency response curve measured for the diaphragm prepared in the present disclosure.

### DETAILED DESCRIPTION OF THE EMBODIMENTS

### Example 1

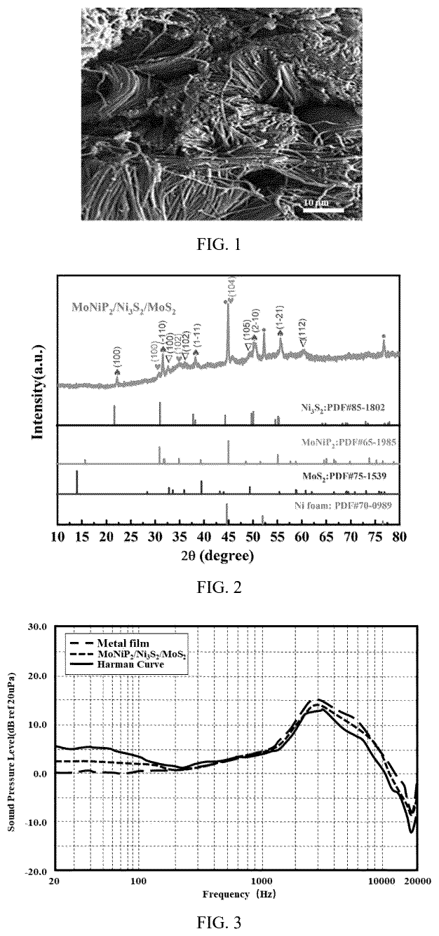

Referring to FIGS. 1 to 3, the present disclosure provides a NiMo-based nanomaterial earphone diaphragm, including a base film and a NiMo-based nanomaterial sprayed on the surface of the base film, where the base film is circular, the nanomaterial is sprayed on the surface of the base film in a concentric ring form to form a NiMo-based nanomaterial coating, concentric rings are interconnected by connecting lines, and the material of the connecting lines is also the NiMo-based nanomaterial.

The NiMo-based nanomaterial is a MoNiP₂/Ni₃S₂/MoS₂ nanomaterial, specifically a rod-shaped cluster structure with a length of rods being about 20 μm and a width of rods between 1.5 and 2 μm.

The NiMo-based nanomaterial coating has a thickness of 300-500 μm.

The base film is a paper base film having a uniform thickness in a range of 10-50 μm and density, and the base film is made from wood pulp, cotton pulp or bamboo pulp.

### Example 2

Referring to FIGS. 1 to 3, a method for preparing the NiMo-based nanomaterial earphone diaphragm includes the following steps:
step A: preparation of the base film
preparing a paper base film to ensure that the base film has a uniform thickness and density, where the base film is made from high-purity wood pulp, cotton pulp or bamboo pulp as a raw material;
step B: pretreatment of the base film
cleaning surface of the base film to remove impurities, and performing surface modification to enhance material adhesion;
step C: preparation of the NiMo-based nanomaterial
preparing a precursor first, then vulcanizing the precursor to prepare a MoNiP₂/Ni₃S₂/MoS₂ nanomaterial;
step F: spraying of the NiMo-based nanomaterial
spraying the NiMo-based nanomaterial evenly on the surface of the paper base film to form a concentric ring distribution; ensuring uniform material distribution without bubbles and cracks, and keeping the thickness of the coating between 300-500 μm; and
step G: spraying of the connecting lines
spraying the NiMo-based nanomaterial as the connecting lines between the concentric rings to ensure the structural integrity of the diaphragm as a whole.

A SEM image of the prepared diaphragm surface is shown in FIG. 1; a frequency response curve of the prepared diaphragm is shown in FIG. 3, in which long dotted lines represent the frequency response curve of the diaphragm sprayed with a metal coating; short dotted lines represent the frequency response curve of the diaphragm prepared in the present disclosure, and the solid line shows a Harman curve.

The preparation of the NiMo-based nanomaterial is specifically as follows:
step C1: preparation of a precursor
firstly, a precursor of a NiMo-based sulfur-phosphorus hybrid catalyst is prepared by a two-step hydrothermal method; in the first step, ammonium molybdate is used as a source of molybdenum and phosphorus, mixed with nickel nitrate hexahydrate and dissolved in deionized water to form a mixture, and the mixture is stirred to form a uniform solution; subsequently, a cleaned nickel foam skeleton is immersed in the solution and heated to 150 degrees Celsius in a 25 mL Teflon-lined autoclave for 6 h; after cooling to room temperature, the obtained product is washed with deionized water and ethanol several times and dried at 60 degrees Celsius for 12 h;
step C2: vulcanization process
100 mg of thiourea is taken and dissolved in 15 mL of deionized water, transferred to a 25 mL Teflon autoclave after ultrasonic dispersion for 15 min, with the precursor soaked therein, so that the liquid surface completely covers the precursor; the autoclave is heated to 200 degrees Celsius and kept warm for 20 h, then cooled to room temperature naturally; finally, the obtained product is washed with deionized water and ethanol multiple times, and dried again at 60 degrees Celsius for 12 h to obtain a black Ni foam, which is made from the MoNiP₂/Ni₃S₂/MoS₂ nanomaterial.

The XRD pattern of the prepared MoNiP₂/Ni₃S₂/MoS₂ nanomaterial is shown in FIG. 2.

The material is mainly composed of three phases. Among them, 44.8°, 52.2° and 76.6° are the three typical characteristic peaks of NF (standard card number: JCPDS No. 70-0989). Diffraction peaks located at 22.24°, 31.56°, 38.20°, 50.16° and 55.6° respectively belong to (100), (−110), (−111), (2-10) and (1-21) crystal planes of Ni₃S₂ (JCPDS No. 85-1802). The diffraction peaks at 30.8°, 35.12° and 44.88° correspond to the (100), (102) and (104) crystal planes of MoNiP₂ (JCPDS No. 65-1895). The diffraction peaks at 32.64°, 35.98°, 45.8° and 60.5° correspond to the (100), (102), (105) and (112) crystal planes, indicating the formation of MoS₂ (JCPDS No. 80-0375).

The specific steps for surface modification to enhance material adhesion in step B are as follows:
the base film needs to be cleaned to remove dust and grease on the surface, and ultrasonic cleaning and chemical solvent cleaning are used in a combined manner to ensure a cleanliness of the surface of the base film;
the cleaned base film is placed in a plasma generator, and oxygen, argon or nitrogen was used to generate plasma; chemical properties of the surface of the base film are changed to increase surface energy, improve its hydrophilicity and surface activity, thereby enhancing the adhesion of subsequent spraying materials;
after plasma treatment, a layer of adhesion promoter will be sprayed on the surface of the base film;
afterwards, ultraviolet light irradiation is performed to further improve surface activity and enhances adhesion; and
before spraying, the base film is preheated to increase the surface temperature to enable rapid curing and better adhesion of the sprayed material.

The adhesion promoter is selected from a silane coupling agent or acrylics.

An ultraviolet wavelength is in the range of 250-280 nm, an irradiation intensity of ultraviolet light is set to be 30-50 mW/cm², an exposure time of the base film under ultraviolet light is 10-20 min, and a distance between the ultraviolet light source and the surface of the base film is controlled between 10-20 cm.

The spraying of the NiMo-based nanomaterials in step F is as follows:
spraying preparation: the MoNiP₂/Ni₃S₂/MoS₂ nanomaterial is mixed with a solvent and an auxiliary agent to prepare a uniform and stable suspension, where the solvent is selected from deionized water or ethanol, and the auxiliary agent is selected from sodium dodecyl sulfate or polyvinyl pyrrolidone;
setting of spraying parameters: an electrostatic spraying equipment is used, a distance between the spray gun and the base film is adjusted to be 15-25 cm, a spraying voltage is set to be 30-50 kV, and an air pressure is 0.3-0.5 Mpa;
spraying operation: under constant spraying parameters, the prepared MoNiP₂/Ni₃S₂/MoS₂ suspension is evenly sprayed on the surface of the pretreated paper base film to form a concentric ring distribution, and the thickness of the coating is controlled between 300-500 μm;
spraying path planning: in order to ensure uniform material distribution, the spraying path needs to be planned in advance, and a spiral or reciprocating spraying path is used to avoid repeated spraying at the same location so as to avoid local accumulation; and
curing treatment: after the spraying is completed, the diaphragm is placed in an oven and subjected to heat treatment at 80 to 100° C. to promote the curing of the coating and enhance the adhesion and stability of the material.

The spraying of the connecting lines from the NiMo-based nanomaterial in step G is as follows:
preparation before spraying: after completing the preliminary spraying of the NiMo-based nanomaterial, it is ensured that the concentric ring coating on the base film is completely dry and without any defects;
design of the connecting lines: the location and direction of the connecting lines are determined to ensure that the connecting lines are evenly distributed among the concentric rings to form a grid structure and enhance the stability and conductive performance of the overall structure;
spraying parameter adjustment: the parameters of the electrostatic spraying equipment are adjusted, including spraying voltage and air pressure;
spraying operation for the connecting lines: the same spraying equipment and parameters are used as in step F, the MoNiP₂/Ni₃S₂/MoS₂ nanomaterial suspension is accurately sprayed on a preset location of the connecting lines to form a continuous and uniform connecting line coating; and
secondary curing: after completing the spraying of the connecting lines, the diaphragm is placed in the oven again for a second curing process.

The planning method for the rings and the position of the connecting lines is as follows:
based on a diameter D of the earphone diaphragm and a center frequency f of the diaphragm, an optimal spacing and layout between the rings and the connecting lines are calculated to ensure the optimization of acoustic performance and conductive performance, using a formula:

$$S = v / 2 N π f ;$$

where v is a speed of sound waves propagating in air, f is a center frequency, S is a spacing between the rings, N is a positive integer that is selected from 2 to 5;
in order to ensure good conductive performance, a density of the connecting lines should satisfy a formula:

$${D}_{c} = {I}_{max} / σ A ;$$

where Iₘₐₓ is the maximum operating current, σ is a conductivity of the NiMo-based nanomaterials, and A is a cross-sectional area of a single connecting line.

So far, the description of the above-described embodiments has been provided for the purposes of illustration and description. It is not intended to be exhaustive or to limit the present disclosure. Individual elements or features of a particular embodiment are generally not limited to that particular embodiment, but, where applicable, may be interchanged and used in a selected embodiment even if not specifically shown or described. In many respects, the same elements or features may vary. Such changes are not considered a departure from the present disclosure and all such modifications are intended to be included within the scope of the present disclosure.

Exemplary embodiments are provided so that the present disclosure will be thorough, and will fully convey the scope to those skilled in the art. In order to provide a thorough understanding of embodiments of the present disclosure, numerous details are set forth, such as examples of specific parts, devices, and methods. It will be apparent to those skilled in the art that specific details need not be employed, that exemplary embodiments may be embodied in many different forms, and neither should be construed to limit the scope of the present disclosure. In some exemplary embodiments, well-known processes, well-known device structures, and well-known technologies are not described in detail.

The terminology used herein is solely for the purpose of describing particular exemplary embodiments and is not intended for purpose of limitation. As used herein, the singular forms “a”, “an” and “the” are intended to include the plural forms as well, unless the context clearly indicates otherwise. The terms “including” and “having” mean inclusive and thus specify the presence of stated features, integers, steps, operations, elements and/or components, but do not exclude the presence or addition of one or more other features, integers, steps, operations, elements, components and/or combinations thereof. Unless the order of performance is expressly indicated, the method steps, processes, and operations described herein are not to be construed as necessarily needing to be performed in the specific order discussed and illustrated. It should also be understood that additional or alternative steps may be employed.

1. A NiMo-based nanomaterial earphone diaphragm, comprising a base film and a NiMo-based nanomaterial sprayed on a surface of the base film, wherein the base film is circular, the nanomaterial is sprayed on the surface of the base film in a form of concentric rings to form a NiMo-based nanomaterial coating, the concentric rings are interconnected by connecting lines, and materials of the connecting lines are also the NiMo-based nanomaterial;
the NiMo-based nanomaterial is a MoNiP₂/Ni₃S₂/MoS₂ nanomaterial, specifically a rod-shaped cluster structure with a length of rods being about 20 μm and a width of rods being between 1.5 and 2 μm; and
the NiMo-based nanomaterial coating has a thickness of 300-500 μm.

2. The NiMo-based nanomaterial earphone diaphragm according to claim 1, wherein the base film is a paper base film having a uniform thickness in a range of 10-50 μm and density, and the base film is made from wood pulp, cotton pulp or bamboo pulp.

3. A method for preparing the NiMo-based nanomaterial earphone diaphragm according to claim 1, comprising the following steps:
step A: preparation of the base film
preparing the paper base film to ensure that the base film has a uniform thickness and density, wherein the base film is made from high-purity wood pulp, cotton pulp or bamboo pulp as raw materials;
step B: pretreatment of the base film
cleaning the surface of the base film to remove impurities, and performing surface modification to enhance material adhesion;
step C: preparation of the NiMo-based nanomaterial
preparing a precursor first, then vulcanizing the precursor to prepare a MoNiP₂/Ni₃S₂/MoS₂ nanomaterial;
step F: spraying of the NiMo-based nanomaterial
spraying the NiMo-based nanomaterial evenly on the surface of the paper base film to form a concentric ring distribution, ensuring a uniform material distribution without bubbles and cracks, and keeping the thickness of the coating between 300-500 μm; and
step G: spraying of the connecting lines
spraying the NiMo-based nanomaterial as the connecting lines between the concentric rings to ensure the structural integrity of the diaphragm as a whole.

4. The method for preparing the NiMo-based nanomaterial earphone diaphragm according to claim 3, wherein the preparation of the NiMo-based nanomaterial is as follows:
step C1: preparation of a precursor
firstly, the precursor of a NiMo-based sulfur-phosphorus hybrid catalyst is prepared by a two-step hydrothermal method; in the first step, ammonium molybdate is used as a source of molybdenum and phosphorus, mixed with nickel nitrate hexahydrate and dissolved in deionized water to form a mixture, and the mixture is stirred to form a uniform solution; subsequently, a cleaned nickel foam skeleton is immersed in the solution and heated to 150 degrees Celsius in a 25 mL Teflon-lined autoclave for 6 h; after cooling to room temperature, the obtained product is washed with deionized water and ethanol several times and dried at 60 degrees Celsius for 12 h;
step C2: vulcanization process
100 mg of thiourea is taken and dissolved in 15 mL of deionized water, and transferred to a 25 ml Teflon autoclave after ultrasonic dispersion for 15 min, with the precursor soaked therein, so that liquid surface completely covers the precursor; the autoclave is heated to 200 degrees Celsius and kept warm for 20 h, then cooled to room temperature naturally; finally, the obtained product is washed with deionized water and ethanol several times, and dried again at 60 degrees Celsius for 12 h to obtain a black Ni foam, being the MoNiP₂/Ni₃S₂/MoS₂ nanomaterial.

5. The method for preparing the NiMo-based nanomaterial earphone diaphragm according to claim 3, wherein specific steps for the surface modification to enhance material adhesion in step B are as follows:
the base film needs to be cleaned to remove dust and grease on the surface, and ultrasonic cleaning and chemical solvent cleaning are used in a combined manner to ensure a cleanliness of the surface of the base film;
the cleaned base film is placed in a plasma generator, and oxygen, argon or nitrogen is used to generate plasma; chemical properties of the surface of the base film are changed to increase surface energy, improve its hydrophilicity and surface activity, thereby enhancing adhesion of subsequent spraying materials;
after plasma treatment, a layer of adhesion promoter will be sprayed on the surface of the base film;
afterwards, ultraviolet light irradiation is performed to further improve surface activity and enhance adhesion; and
before spraying, the base film is preheated to increase surface temperature to enable rapid curing and better adhesion of the spraying material.

6. The method for preparing the NiMo-based nanomaterial earphone diaphragm according to claim 5, wherein the adhesion promoter is selected from a silane coupling agent or acrylics.

7. The method for preparing the NiMo-based nanomaterial earphone diaphragm according to claim 3, wherein an ultraviolet wavelength is in a range of 250-280 nm, an irradiation intensity of ultraviolet light is set to be 30-50 mW/cm², an exposure time of the base film under ultraviolet light is 10 to 20 minutes, and a distance between an ultraviolet light source and the surface of the base film is controlled between 10 and 20 cm.

8. The method for preparing the NiMo-based nanomaterial earphone diaphragm according to claim 3, wherein the spraying of the NiMo-based nanomaterial in step F is as follows:
spraying preparation: the MoNiP₂/Ni₃S₂/MoS₂ nanomaterial is mixed with a solvent and an auxiliary agent to prepare a uniform and stable suspension, wherein the solvent is selected from deionized water or ethanol, and the auxiliary agent is selected from sodium dodecyl sulfate or polyvinyl pyrrolidone;
setting of spraying parameters: an electrostatic spraying equipment is used, a distance between a spray gun and the base film is adjusted to be 15-25 cm, a spraying voltage is set to be 30-50 kV, and an air pressure is 0.3-0.5 Mpa;
spraying operation: under constant spraying parameters, the prepared MoNiP₂/Ni₃S₂/MoS₂ suspension is evenly sprayed on the surface of the pretreated paper base film to form a concentric ring distribution, and the thickness of the coating is controlled between 300-500 μm;
spraying path planning: in order to ensure uniform distribution of the material, the spraying path needs to be planned in advance, and a spiral or reciprocating spraying path is used to avoid repeated spraying at the same location so as to avoid local accumulation; and
curing treatment: after the spraying is completed, the diaphragm is placed in an oven and subjected to heat treatment at 80-100° C. to promote the curing of the coating and enhance the adhesion and stability of the material.

9. The method for preparing the NiMo-based nanomaterial earphone diaphragm according to claim 3, wherein the spraying of the connecting lines for the NiMo-based nanomaterial in step G is as follows:
preparation before spraying: after completing a preliminary spraying of the NiMo-based nanomaterial, it is ensured that the coating of concentric rings on the base film is completely dry and without any defects;
design of the connecting lines: a location and direction of the connecting lines are determined to ensure that the connecting lines are evenly distributed among the concentric rings to form a grid structure and enhance the stability and conductivity of the overall structure;
adjustment of spraying parameters: the parameters of an electrostatic spraying equipment are adjusted, including spraying voltage and air pressure;
spraying operation for the connecting lines: the same spraying equipment and parameters are used as in step F, the MoNiP₂/Ni₃S₂/MoS₂ nanomaterial suspension is accurately sprayed on a preset location of the connecting lines to form a continuous, uniform connecting line coating; and
secondary curing: after completing the spraying of the connecting lines, the diaphragm is placed in the oven again for a second curing process.

10. The method for preparing the NiMo-based nanomaterial earphone diaphragm according to claim 3, wherein the planning method for the rings and the position of the connecting lines is as follows:
based on a diameter D of the earphone diaphragm and a center frequency f of the diaphragm, an optimal spacing and layout between the rings and the connecting lines are calculated to ensure the optimization of acoustic performance and conductive performance, using a formula:
$$S = v / 2 N π f ;$$
wherein v is a speed of sound waves propagating in air, f is a center frequency, S is a spacing of the rings, and N is a positive integer that is selected from 2 to 5;
in order to ensure good conductive performance, a density of the connecting lines should satisfy a formula:
$${D}_{c} = {I}_{max} / σ A ;$$
wherein Iₘₐₓ is the maximum operating current, σ is a conductivity of the NiMo-based nanomaterial, and A is a cross-sectional area of a single connecting line.
